(19) United States
(12) Patent Application Publication
(10) Pub. No.: US 2014/0316941 A1
(43) Pub. Date: Oct. 23, 2014

(54) Self-Adjusting Seller Zones

(71) Applicants: Jayasree Mekala, Austin, TX (US); Kamal Zamer, Austin, TX (US); Praveen Nuthulapati, Austin, TX (US); Jeremiah Joseph Akin, Pleasant Hill, CA (US)

(72) Inventors: Jayasree Mekala, Austin, TX (US); Kamal Zamer, Austin, TX (US); Praveen Nuthulapati, Austin, TX (US); Jeremiah Joseph Akin, Pleasant Hill, CA (US)

(73) Assignee: eBay Inc., San Jose, CA (US)

(21) Appl. No.: 13/865,067

(22) Filed: Apr. 17, 2013

(51) Int. Cl. G06Q 30/06

(52) U.S. Cl. CPC G06Q 30/0613
USPC 705/26.41

(57) ABSTRACT

According to various embodiments, a first group of potential buyers of a product item is identified, and an item listing for sale of the product item is posted on a marketplace website, wherein the item listing being viewable by the first group of potential buyers. Thereafter, if it is determined that the product item has been purchased by at least one member of the first group within a predetermined time interval, the item listing is closed. On the other hand, if it is determined that the product item has not been purchased by at least one member of the first group within the predetermined time interval, a second group of potential buyers may be identified. Thereafter, the item listing may be modified to generate a modified item listing being viewable by both the first and second groups of potential buyers.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to the technical field of electronic data and, in one specific example, to systems and methods for publishing item listings based on self-adjusting seller zones.

### BACKGROUND

Marketplace websites allow sellers to post various product items for sale online to the general public. Typically, the seller logs into the marketplace website and manually generates an item listing that describes the product item that the seller wishes to sell. Thereafter, the item listing may be posted on the marketplace website for viewing by the general public.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 illustrates an exemplary flow demonstrating how an item listing may be exposed to different “zones” or groups of potential buyers over time, according to various embodiments.

FIG. 4 is a flowchart illustrating an example method, according to various embodiments.

FIG. 5 illustrates an exemplary portion of a user interface that displays an item listing, according to various exemplary embodiments.

FIG. 6 is a flowchart illustrating an example method, according to various embodiments.

FIG. 7 illustrates an exemplary portion of a user interface, according to various exemplary embodiments.

FIG. 8 illustrates an exemplary portion of a user interface, according to various exemplary embodiments.

FIG. 9 is a flowchart illustrating an example method, according to various embodiments.

FIG. 10 illustrates an exemplary portion of a user interface that displays an item listing, according to various exemplary embodiments.

FIG. 11 is a flowchart illustrating an example method, according to various embodiments.

FIG. 12 illustrates an exemplary portion of a user interface, according to various exemplary embodiments.

FIG. 13 illustrates an exemplary portion of a user interface, according to various exemplary embodiments.

FIG. 14 is a flowchart illustrating an example method, according to various embodiments.

FIG. 15 is a diagrammatic representation of a machine in the example form of a computer system within which a set of instructions, for causing the machine to perform any one or more of the methodologies discussed herein, may be executed.

### DETAILED DESCRIPTION

Example methods and systems for publishing item listings based on self-adjusting seller zones are described. In the following description, for purposes of explanation, numerous specific details are set forth in order to provide a thorough understanding of example embodiments. It will be evident, however, to one skilled in the art that the present invention may be practiced without these specific details.

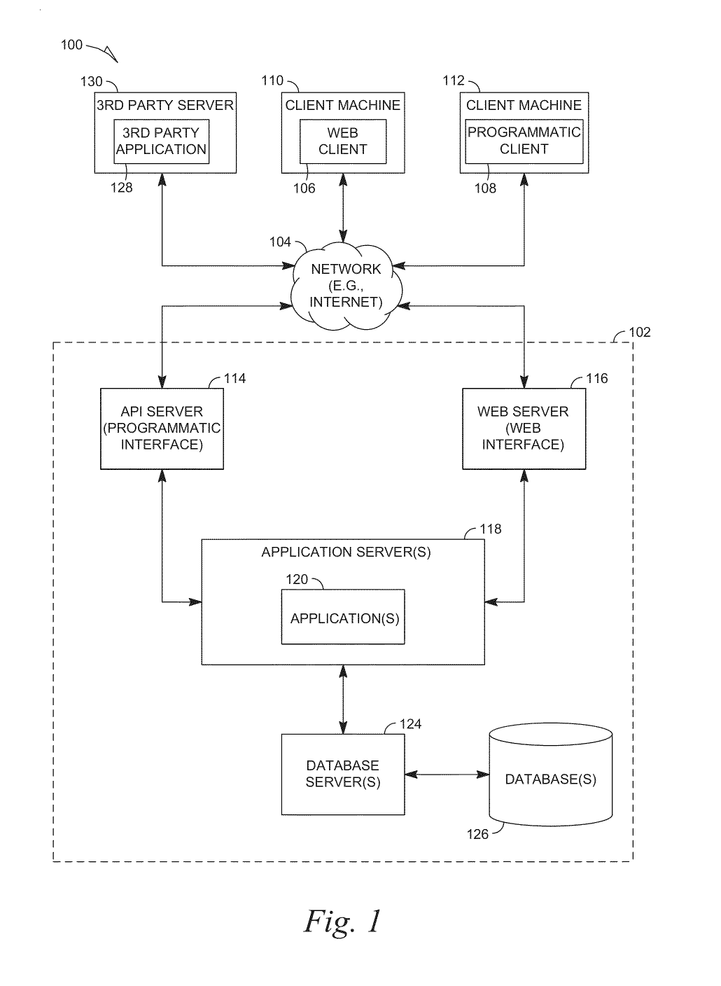

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

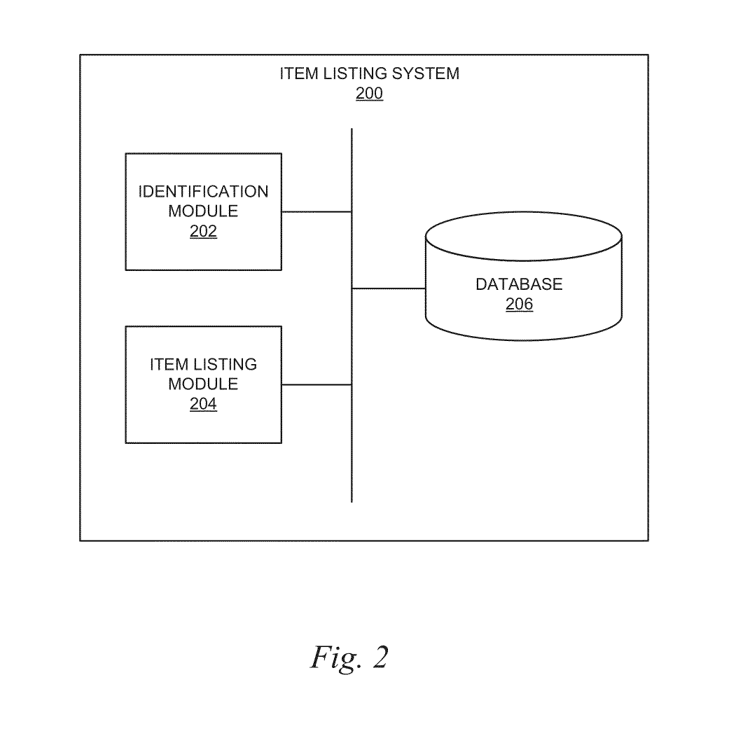

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may correspond to one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, an item listing system 200 includes an identification module 202, an item listing module 204, and a database 206. The modules of the item listing system 200 may be implemented on a single device such as an item listing device, or on separate devices interconnected via a network. The aforementioned item listing device may correspond to, for example, one of the client machines (e.g. 110, 112) or application server(s) 118 illustrated in FIG. 1.

According to various exemplary embodiments, the item listing system 200 enables a seller of a product item to target an item listing at specific markets of potential buyers on a marketplace website, such as Ebay.com. For example, various product items may hold the greatest interest within a specific market, or may be more likely to be sold within specific markets. Thus, instead of simply publishing all the item listings on a marketplace website to the entire general public, the item listing system 200 of this disclosure enables a seller of a product item to publish item listings that are targeted at specific markets or groups of potential buyers, in order to allow the seller to obtain the maximum price for the product item, and to realize various other benefits, such as achieving the most convenient type of transaction possible, enhancing the relationship that the seller has within various specific markets, supporting enthusiast sub-communities, and so on.

According to various exemplary embodiments, the item listing system 200 enables a seller to publish an item listing (e.g., for sale of a product item) that is incrementally visible to new “zones” or groups of people over time. For example, as the age of the listing increases, more “zones” or groups of people may be able to view the item listing. This incremental exposure of the item listing to new zones of people may continue until the item listing is viewable by all users (e.g., the general public, a general user base of a marketplace website, etc.), or until the product item has been sold successfully.

According to various exemplary embodiments, zones may correspond to groups of people that share any type of characteristic, trait, quality, or property in common. For example, zones may be defined based on users that have certain social media content, profile information, purchase histories, relationships on a social graph or social network service, contacts lists, geographic location, and so. Some simple examples of zones include “friends of my friends on Facebook”, “people that live in New York City and that have liked the NY Giants page on Facebook”, “people who have purchased antiques in the past 6 months that live within 5 miles of me”, and so on.

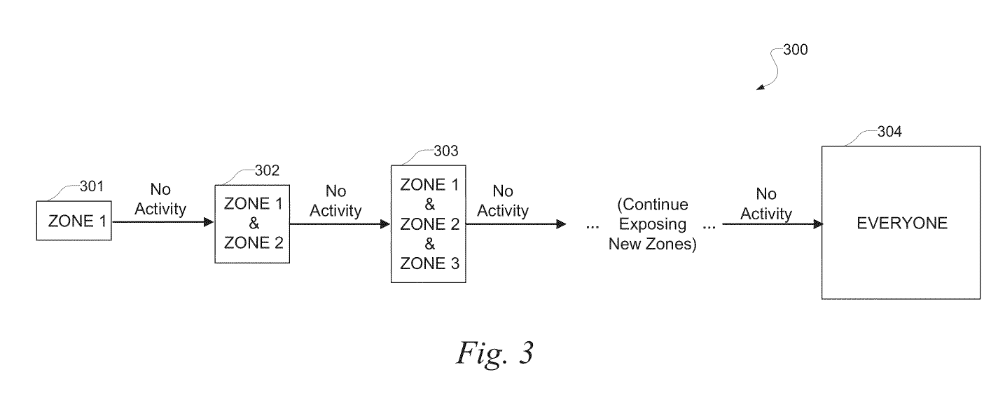

FIG. 3 illustrates an example of a flow diagram illustrating how an item listing may be incrementally exposed to new zones by the item listing system 200. Initially, an item listing may be viewable by a first zone of buyers in 301. If no activity occurs within a predetermined time interval (e.g., the product item in the item listing has not been sold), then the item listing may be exposed to a second zone of buyers in 302 (e.g., the item listing may be modified so it is viewable by the first zone and the second zone of buyers). If there is still no activity within a predetermined time interval (e.g., the product item has still not been sold), then the item listing may be exposed to a third zone of buyers in 303 (e.g., the item listing may be modified again so that it is viewable by the first zone, the second zone, and a third zone of buyers). This process of adjusting the visibility of the item listing to more and more groups or “zones” of potential buyers may continue until the item listing is viewable by all users (e.g., the general public, a general user base of a marketplace website, etc.) in 304, or until product item has been sold.

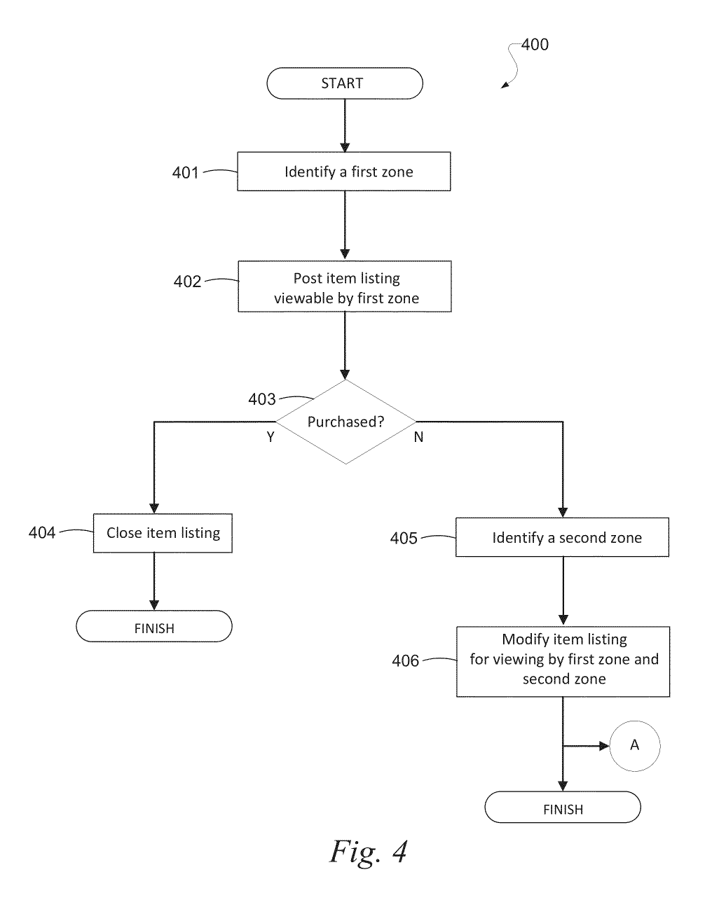

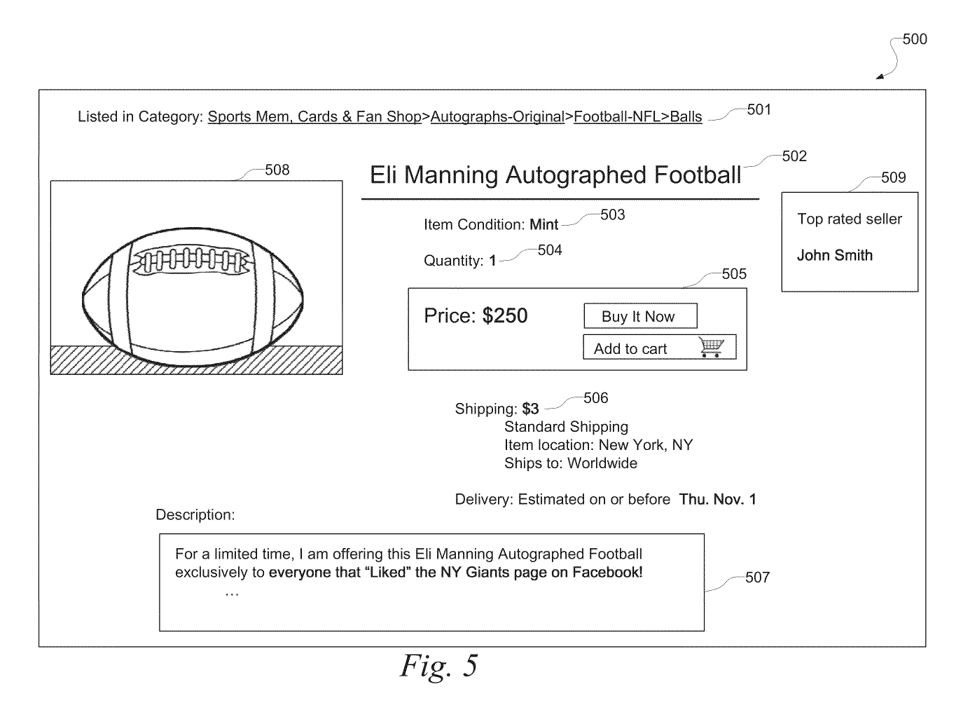

Turning now to FIG. 4, a flowchart illustrates an example method 400, according to various embodiments. The method 400 may be performed at least in part by, for example, the item listing system 200 illustrated in FIG. 2 (or an apparatus having similar modules, such as client machines 110 and 112 or application server 112 illustrated in FIG. 1). In 401, the identification module 202 identifies a first “zone” (or group) of potential buyers of a product item. As described in more detail below, the identification module 202 may identify a zone of potential buyers based on a specification (e.g., by a seller of the product item) of one or more properties, characteristics, traits, or qualities of the members of that zone. For example, as described in more detail below, the item listing system 200 may display a user interface enabling a seller to specify a zone such as “all users who have “liked” the NY Giants page on Facebook”, and the identification module 204 may proceed to identify users of the marketplace website that are in such a zone. In 402 in FIG. 4, the item listing module 204 posts, on a marketplace website, an item listing for sale of the product item, where the item listing is viewable by the first zone of potential buyers that was identified in 401. An example of an item listing 500 posted on a marketplace website (e.g., eBay.com) for a product item (e.g., a football autographed by the football player “Eli Manning”) is illustrated in FIG. 5. The item listing 500 includes various information such as a category associated with the product item 501, a title of the product item 502, a condition of the product item 503, a quantity of the product item 504, a price associated with the product item 505, the shipping costs associated with the product item 506, a description of the product item 507, a picture or photograph of the product item 508, and seller information describing the seller 509.

Referring back to the method 400 in FIG. 4, the item listing posted by the item listing module 204 (in 402) is viewable by the first zone of potential buyers that was identified in 401. According to an exemplary embodiment, the item listing posted is viewable “only” by the first zone of potential buyers from among a general user base of potential buyers of the marketplace website. In other words, while the item listing is viewable by the first zone of potential buyers, it is not viewable by other regular users of the marketplace website (who are not also members of the first zone), or other regular members of the general user base of the marketplace website (who are not also members of the first zone). For example, the item listing module 204 may control visibility or accessibility settings/parameters associated with the item listing, so that it is viewable by users included in the first zone (e.g., all the users that have “liked” the NY Giants page on Facebook), but not viewable by other regular users of the marketplace website (who are not also members of the first zone) or other regular members of the general user base of the marketplace website (who are not also members of the first zone)

While the visibility of the item listing may be restricted to potential buyers in the first zone, it should be understood that the item listing may still be accessible by various authorized users of the marketplace website. For example, according to an exemplary embodiment, the operation 402 may comprise restricting access to the item listing to members of the first zone, as well as members of a “special” or “exempt” zone. The members of the special zone may include the seller that posted the item listing, other sellers, authorized personnel associated with the marketplace website (e.g., employees, staff, workers, executives, contractors, moderators, help desk personnel, customer service personnel, IT and technical support personnel, security personnel, anti-fraud personnel, etc.), members of law enforcement, government employees, other authorized users of the marketplace website that—for one reason or another—have status or rights that permit them access to all item listings on the marketplace website, and so on.

In 403 in FIG. 4, the identification module 202 determines whether or not the product item has been purchased (e.g., by at least one member of the first zone) within a predetermined time interval. As described in various embodiments below, the item listing system 200 may display a user interface allowing the seller to set the predetermined time interval to any time interval, such as, for example, 12 hours, two days, one week, etc. If the identification module 202 determines (in 403) that the product item has been purchased within the predetermined time interval, then in 404, the item listing module 204 terminates or closes the item listing. On the other hand, if the identification module 202 determines (in 403) that the product item has not been purchased within the predetermined time interval, then in 405, the identification module 202 identifies a second zone of potential buyers of the product item. For example, as described in more detail below, the item listing system 200 may display a user interface enabling a seller to specify a second zone such as “people who have purchased a football in the past six months”, and the identification module 204 may proceed to identify users of the marketplace website that are in such a zone. In 406, the item listing module 204 modifies the item listing (e.g., the item listing 500 illustrated in FIG. 5) so that it is viewable by both the first and second zones of potential buyers. For example, the item listing module 204 may modify visibility or accessibility settings/parameters of the item listing to generate a modified item listing, where the modified item listing is viewable by the first and second zones of potential buyers. Note that instead of modifying the item listing in 406, the item listing module 204 may instead generate a new corresponding item listing.

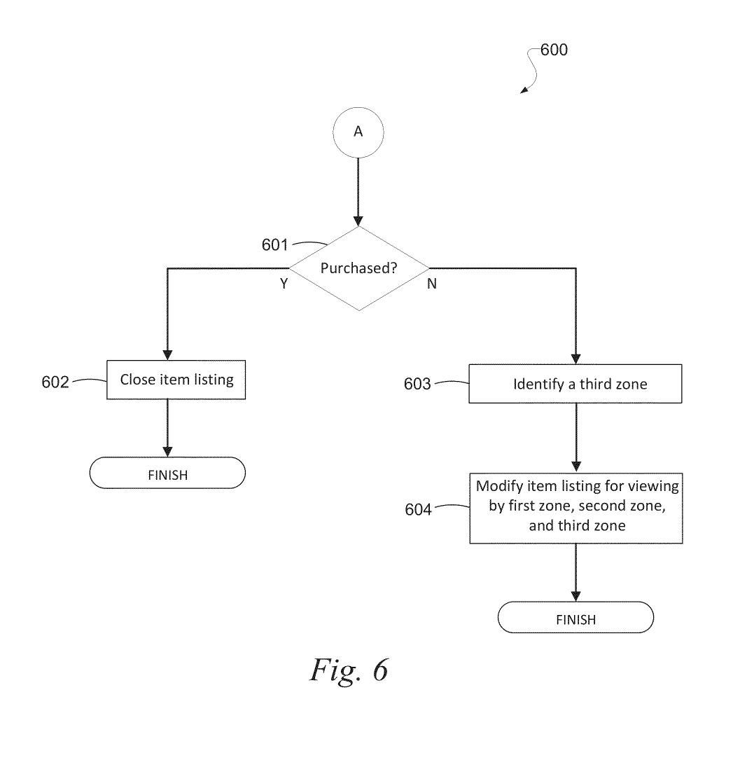

If the product item still has not been purchased after a certain time interval, a third zone of potential buyers may be identified, and the item listing may be modified so that it is viewable by the first, second, and third zones of potential buyers. For example, FIG. 6 is a flowchart illustrating an example method 600, according to various embodiments. The method 600 may be performed at least in part by, for example, the item listing system 200 illustrated in FIG. 2 (or an apparatus having similar modules, such as client machines 110 and 112 or application server 112 illustrated in FIG. 1). The method 600 may start at “A”, (i.e., after 406 in the method 400 and FIG. 4). In 601, the identification module 202 determines whether or not the product item has been purchased (e.g., by at least one member of the first zone or the second zone) within a predetermined time interval. If the identification module 202 determines (in 601) that the product item has been purchased within the predetermined time interval, then in 602, the item listing module 204 terminates or closes the item listing. On the other hand, if the identification module 202 determines (in 601) that the product item has not been purchased within a predetermined time interval, then in 603, the identification module 202 identifies a third zone of potential buyers of the product item, and in 604, the item listing module 204 modifies the item listing so that it is viewable by first, second, and third zones of potential buyers. Note that various operations in the methods 400 and 600 may be rearranged. For example, the identification of various zones (see operations 401, 405, and 603) may occur before various other operations (e.g., before 402 in the method 400).

Accordingly, this incremental exposure of the item listing to new “zones” or groups of people may continue until the item listing is viewable by all users (e.g., the general public, a general user base of a marketplace website, etc.), or until the product item has been successfully sold. According to an exemplary embodiment, the item listing system 200 may incrementally expose an item listing to new zones over time, by excluding various groups from viewing the item listing, and then later permitting these various groups to view the listing as the item listing ages. For example, the operation 402 in FIG. 2 may comprise posting an item listing, and permitting the item listing to be viewed by all users in the first zone, but excluding users in the second zone or third zone (who are not also in the first zone) from viewing the item listing. Thereafter, the operation 406 in FIG. 4 may comprise permitting the item listing to be viewed by all users in the first zone and the second zone, but excluding users in the third zone (who are not also in the first zone or the second zone) from viewing the item listing

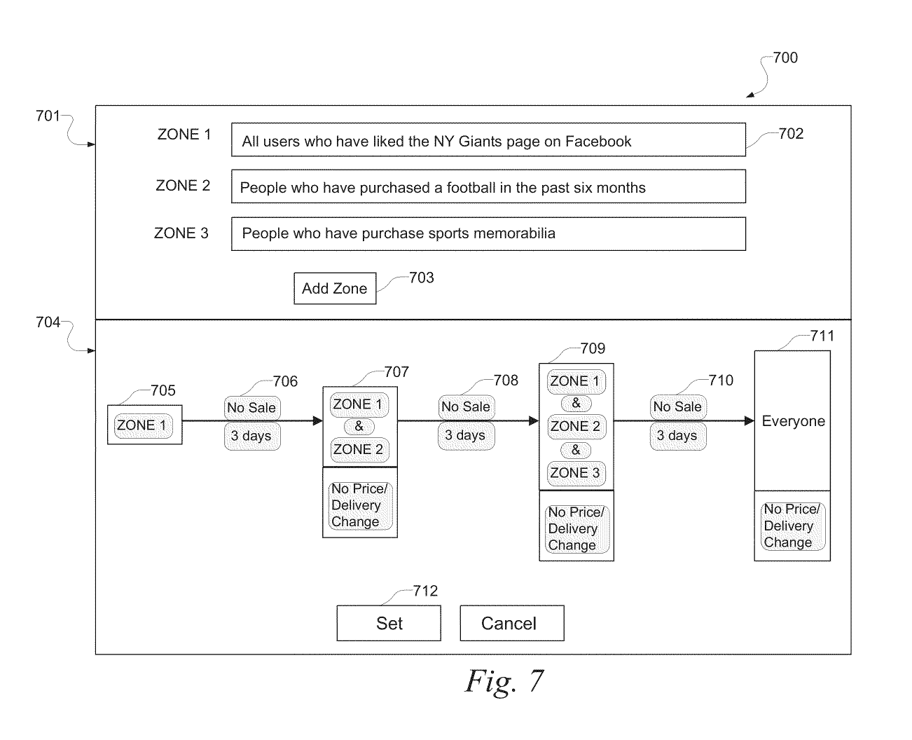

FIG. 7 illustrates an example of a user interface 700 displayed by the item listing system 200, which may be displayed when a user is generating a new listing. The user interface 700 includes a zone definition area 701 with zone definition entry fields 702 where the user can define various zones, by specifying the parameters, features, or characteristics of users in those zones. For example, the user can type in the parameter “all users who Liked the New York Giants page on Facebook” for Zone 1, or type in the parameter “people who have purchased a football in the past six months” for Zone 2, and so on. The user can select the “add zone” user interface element 703 in order to add parameters for additional zones. The user interface 700 also includes a flow definition area 704 where the user can control the various conditions or settings by which an item listing is incrementally exposed to different zones over time. In particular, the flow definition area 704 includes a number of item listing stages 705, 707, 709, and 711, and conditional connectors 706, 708 and 710 between the item listing stages. The user can specify that at a first item listing stage 705, the item listing is exposed to Zone 1 (but not Zone 2 or Zone 3). Thereafter, the user can set condition information 706 to specify that if no sale has occurred within three days, then the item listing is modified at item listing stage 707 so that the item listing is now exposed to Zones 1 and 2 (but not Zone 3). Thereafter, the user can set conditional information 708 to specify that if no sale has occurred within three more days, then the item listing is modified at item listing stage 709 so that it is exposed to Zones 1, 2, and 3. Finally, the user can set conditional information 710 to specify that if no sale has occurred within three more days, the item listing is modified in item listing stage 711 so that it is viewable to all users.

The flow definition area 704 includes various user interface elements enabling a user to modify any of the information therein. For example, if the user selects an item listing stage (e.g., 705, 707, 709, 711), the item listing system 200 may display a pop-up window menu allowing the user to select a zone, add a zone, remove a zone, or change a combinational relationship between zones (e.g., Zone 1 “and” Zone 2, Zone 1 “or” Zone 2, etc.) for this item listing stage. If the user selects a conditional connection (e.g., 706, 708, 710), the item listing system 200 may display a pop-up window menu allowing the user to select a condition (e.g., “No Sale”) and an associated time frame (e.g., within “3 days”). Other examples of conditions include references to a number of views an item listing has received, a number of shares an item listing has received, a number of times the item listing has been added to a wish list or save list, a number of times the item listing has been added to a cart/checkout, etc. If the user selects the “Set” button 712, the various settings in the user interface 700 are stored and applied to the appropriate item listing, to expose the item listing to new zones based on the settings.

In some embodiments described herein, an exemplary item listing is incrementally exposed to new zones while remaining visible to previously exposed zones (e.g., the item listing is first exposed to Zone 1 but not Zone 2 or Zone 3, and the item listing is then exposed to Zone 1 and Zone 2 but not Zone 3, and the item listing is then exposed to Zone 1, Zone 2, and Zone 3, etc.). According to another exemplary embodiment, as the item listing ages, the item listing system 200 can expose the item listing to any zones or any combination of zones (e.g., the item listing is first exposed to Zone 1 but not Zone 2 or Zone 3, and thereafter the item listing is exposed to Zone 2 but not Zone 1 or Zone 3, and thereafter the item listing is exposed to Zone 3 but not Zone 1 or Zone 2, etc.).

The zones described throughout may be groups of people that share any type of characteristic, trait, quality, or property in common. According to an exemplary embodiment, a zone may correspond to a group of people who have similar social network content (e.g., likes, tweets, follows, shares, posts, reposts, comments, +1s). Such social network content may correspond to user preference information, since it may indicate the preferences or interests of various users. For example, a seller may specify criteria for a zone of potential buyers based on social network content (e.g., “people who have liked the XYZ camera on Facebook”, “people who have commented on Jim's Mobile Trends article on LinkedIn”, “people who have tweeted about tablet computers”, “people who have checked in at Pete's Chinese restaurant on Facebook”, etc.), and the identification module 202 may access social media information of various users of a marketplace website, in order to identify specific users that are members of this zone. For example, the identification module 202 may access social media profiles of users via a social network service (e.g., Facebook, LinkedIn, etc.).

According to another exemplary embodiment, a zone may correspond to a group of users that have similar user profile information or social media profile information (e.g., name, birthdate, age, ethnicity, location, employer, education, skills and expertise, groups, hobbies, interests, etc.). For example, a seller may utilize the user interface 700 to specify criteria for a zone of potential buyers based on profile information (e.g., “people who are over the age of 18”, “people who are located in the San Francisco Bay area”, “people who attended the University of Michigan”, “people who work at a law firm”, “people who are computer engineers”, etc.), and the identification module 202 may access social media information of various users of a marketplace website, in order to identify specific users that are members of this zone. For example, the identification module 202 may access social media profiles of users via a social network service (e.g., Facebook, LinkedIn, etc.).

According to another exemplary embodiment, a zone may correspond to a group of people that share some type of interaction history with content (e.g., people that viewed, read, listened, watched, or commented on a particular piece or type of online content). For example, a seller may utilize the user interface 700 to specify criteria for a zone of potential buyers based on interaction histories (e.g., “people who have viewed Michael Jordan's weblog”, “people who have watched the funny cat YouTube video”, “people who have listened to Beethoven on Pandora”, “people who have read article XYZ on the New York Times webpage”, etc.), and the identification module 202 may access viewership information associated with various online content sources in order to determine specific users that are members of this zone. For example, the identification module 202 may access the source of the content itself (e.g., the website, weblog, online content hosting service, video sharing servers, etc.) in order to determine the viewers that have viewed or commented on such content. As another example, the identification module 202 may access social media profiles of users via a social network service (e.g., Facebook, LinkedIn, etc.), in order to determine if a social media profile or a content feed associated with this user indicates that they have interacted with such contact.

According to another exemplary embodiment, a zone may correspond to a group of people that share a specific type/degree of connection with the seller on a social graph and/or social network service (e.g., people that have a first-degree connection, second-degree connection, or some other degree of connection with the seller). For example, a seller may utilize the user interface 700 to specify criteria for a zone of potential buyers based on a social graph connection (e.g., “my family on Facebook”, “my friends on Facebook”, “friends of my friends on Facebook”, “my connections on LinkedIn”, “my first, second and third-degree connections on LinkedIn or Facebook”, etc.), and the identification module 202 may access social graph information or social media information exposed by a social media platform or social network service via one or more APIs, in order to determine specific users that are members of this zone.

Consistent with various exemplary embodiments described above, the identification module 202 may crawl through all the data, metadata, and information associated with a user's publically accessible profile page. If the item listing system 200 has an appropriate access agreement with the social networking platform and/or the user, the item listing system 200 may also crawl through all the data, metadata or information associated with the user's private profile page. The item listing system 200 can access the social network platform itself to access social media identity information or user profile information regarding the registered user from information available in the user's social profile. Any publically available social media identity information regarding the user may be obtained from other social media or online sources as well. Social media platforms may expose social media identity information in some sort of application programming interface (API) that is accessible by the item listing system 200. Thus, the item listing system 200 may retrieve or be fed user profile information of the user profile pages from application programming interfaces (APIs) that are exposed by the respective social medial platforms.

According to an exemplary embodiment, a zone may correspond to a group of people who have a similar purchase history. For example, a seller may utilize the user interface 700 to specify criteria for a zone of potential buyers based on purchase histories (e.g., “all people who have purchased a football in the past six months”, “people who have made a purchase at Jim's sporting goods”, “people who have spent more than $200 during last Christmas”, etc.), and the identification module 202 may access the purchase histories (e.g., credit card account, checking account, financial account, Paypal account, etc.) of various users of a marketplace website in order to identify specific users that are members of this zone.

According to another exemplary embodiment, a zone may correspond to a group of people that have a certain relationship with the seller (e.g., people identified as family or friends of the seller) based on a list of contacts associated with an e-mail account, instant messaging account, phone directory, etc., of the seller. For example, a seller may utilize the user interface 700 to specify criteria for a zone or group of potential buyers based on contact information (e.g., “my family”, “my work contacts”, “my phone contacts”, etc.), and the identification module 202 may access the contact information of the seller (e.g., a list of contacts associated with an e-mail account, instant messaging account, phone directory, etc., of the seller) in order to identify specific users that are members of this zone.

According to another exemplary embodiment, a zone may correspond to a group of people located at a particular geographic location. For example, a seller may utilize the user interface 700 to specify criteria for a zone or group of potential buyers based on geographic location (e.g., “people located in the San Francisco Bay area”, “people located in the East Village neighbourhood of Manhattan”, “people located in a zip code 10001”, “people located west of the Mississippi River”, etc.), and the identification module 202 may access geo-location information of various users of the marketplace website in order to identify specific users that are members of this zone.

According to another exemplary embodiment, a zone may correspond to a groups of people located within a particular distance from the seller. For example, a seller may utilize the user interface 700 to specify criteria for a zone or group of potential buyers based on distance from a seller (e.g., “users located within 300 feet of me”, “users located within 5 miles of me”, etc.), and the identification module 202 may access the geo-location information of various users of the marketplace website and compare this geo-location information with geo-location information of the seller, in order to identify specific users that are members of this zone.

The item listing system 200 enables a seller to define zones based on a combination various types of characteristics described above (e.g., social media content, social media profile, purchase histories, degrees of connection on a social graph or social network service, contacts lists, geographic location, geographic distance, etc.). For example, suppose a user John wants to sell his Eli Manning autographed football and would rather have it go to one of his fellow NY Giants fans. John lives in Manhattan and would prefer to sell his item locally. The item listing system 200 enables John to target his item listing 500 at a zone of “all users who have ‘Liked’ the NY Giants page on Facebook and live in the greater NYC area.” If the listing is still available and not receiving a lot of activity, the item listing system 200 enables John to also open the listing to other zones such as “people who have purchased a football in the past six months in the greater NYC area” and “people who have ever purchased sports memorabilia in the NYC area”, “the general NYC area public”, and so on, until the item sells. As another example, suppose a user Jane has a 100% silver, antique vase which is very unique and rare, and Jane wants to limit her shipping costs and only deal with local buyers if possible. The item listing system 200 enables Jane to target her item listing at a zone of “my friends on Facebook who have purchased housewares in the last 3 months and who live within 5 miles of me.” If the listing isn't experiencing a lot of activity, the item listing system 200 enables Jane to also open the listing to other zones such as “antique enthusiasts within 5 miles of me” or “people who have ever purchased silver products who live within 5 miles of me”. As another example, suppose the user Kamal is walking down the street and realizes that he has Rock concert tickets in hand which he can't attend to because he'll be out of town on business that day. The item listing system 200 enables Kamal to list his tickets for a zone that is for “people who like Rock bands and are within 10 blocks of me”.

According to an embodiment, the item listing system 200 may incrementally increase the price of the product item as the item listing is incrementally exposed to different zones or more zones. For example, perhaps an item listing for a seller Danny is initially viewable to the seller's family members in a “family” zone, since Danny would rather sell the product item to his family (and is willing to do so at a discounted price). If the item listing is still available after ten days, then the item listing system 200 enables Danny to expose the item listing to the “family” zone and a “friend” zone with a price increase. If the item is still available after an additional ten days, then the item listing system 200 enables Danny to expose the item listing to the “general public” zone with another price increase.

According to another embodiment, the item listing system 200 may incrementally decrease the price of the product item as the item listing is incrementally exposed to different zones or more zones. For example, if an item listing for a collectable item is targeted at a zone of users having a sentimental interest in these collectibles, such users may be willing to pay a higher purchase price than the market due to its sentiment value. If the collectible does not sell, the item listing system 200 may enable a seller to expose the item listing to other zones or to the general public at a lower price. This approach may also be useful for perishable items as their expiration or user-by date gradually approaches, wherein the item listing system 200 allows a seller to expose the item listing to more zones (and ultimately to the general public) with decreasing price adjustments, in order to collect whatever is possible for the item in the remaining time, rather than letting the item go to waste.

With reference again to FIG. 7, if the user selects a item listing stage (e.g., 705, 707, 709, 711), the item listing system 200 may display a pop-up window menu allowing the user to specify whether there is a price change (increase or decrease) or not. For example, as illustrated in FIG. 7, the user interface 700 indicates that there is no price change as the item listing is exposed to Zone 2 (at the item listing stage 707) or as the item listing is exposed to Zone 3 (at the item listing stage 709) or as the item listing is exposed to everyone (at item listing stage 711).

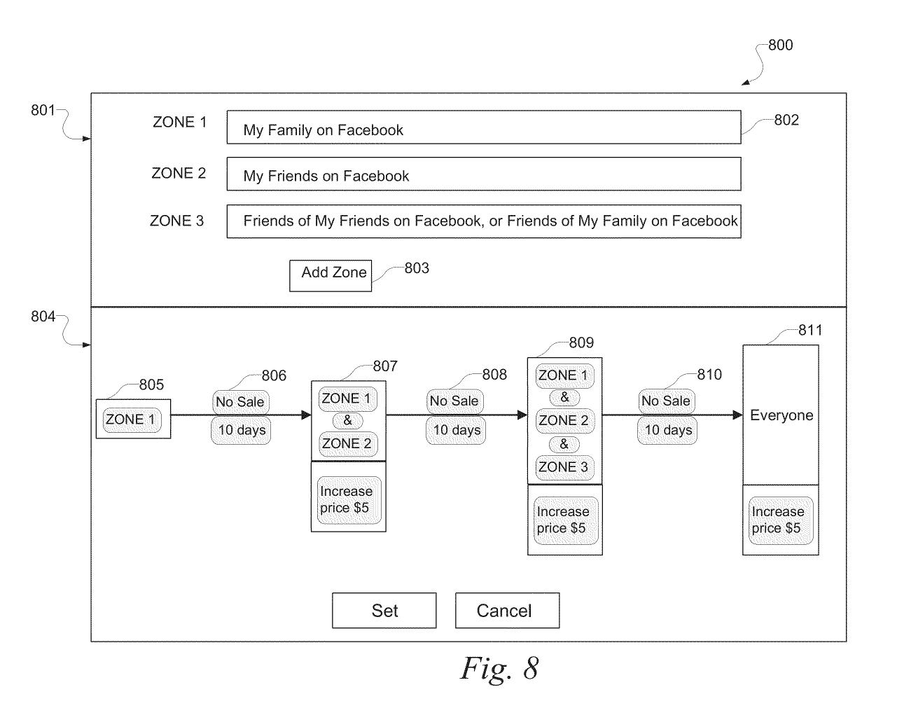

FIG. 8 illustrates an example of another user interface 800 similar to the user interface 700 illustrated in FIG. 7. As illustrated in FIG. 8, the user has specified Zone 1 as “My family on Facebook”, Zone 2 as “My friends on Facebook”, and Zone 3 as “friends of my friends on Facebook, or friends of my family on Facebook”. The item listing is initially exposed to Zone 1 (at item listing stage 805). If the item is not sold within 10 days, then the item is exposed to Zone 2 and the price of the item is increased by $5 (at item listing stage 807). Moreover, if the item listing is not sold within another 10 days, the item listing is exposed to Zone 3, and the price of the item is increased by a further $5 (at item listing stage 809). Further, if the item is still not sold after another 10 days, the item is exposed to all users, and the price of the item is increased again by $5 (at item listing stage 811). According to various exemplary embodiments, the item listing system 200 also enables a seller to specify different prices for different zones of the prospective buyers. For example, if the user selects the item listing stage 807, the item listing system 200 may display a pop-up window menu allowing the user to specify that, for example, there is a price change for Zone 2, but there is no price change for Zone 1 at that item listing stage 807. Similarly, the item listing system 200 enables a seller to specify different conditions (e.g., payment method, delivery options, etc.) for different zones at a given item listing stage.

Consistent with various exemplary embodiments, the item listing system 200 enables a seller to publish item listings that are targeted at groups of potential buyers having the greatest interest or affinity for a product item (e.g., those most likely to spend a greater amount sooner for the product item), to allow a seller to obtain a higher price of the product item in a shorter amount of time. For example, suppose a user John Smith utilizes the item listing system 200 to post the item listing 500 for an Eli Manning autographed football targeted at groups of potential buyers having the greatest interest or affinity for this product item, such as “all users who have “liked” the and NY Giants page on Facebook”, or “people who have purchased a football in the past six months” or “people who work purchase sports memorabilia”. If the item listing 500 generated by the item listing system 200 indicates that the item listing is being marketed exclusively at a particular group of users for a limited time (e.g., see the description section 507 of item listing 500), this may encourage those users to act quickly and pay a higher price in order to “snap up” these items that hold greater interest with them than the general public. This may enable a seller to obtain a higher price of the product item, compared to a case in which the item listing for the product item is viewable by the general public.

According to another exemplary embodiment, the item listing system 200 may also use other techniques in order to market such item listings to the appropriate zone of buyers. For example, the item listing system 200 may promote these item listings to the zone of buyers by transmitting notifications to those buyers (e.g., an e-mail message, text message, or instant message) including content similar to the description 507 in FIG. 5. As another example, the item listing system 200 may promote these item listings to the appropriate zone of buyers by placing such item listings higher in the search results page than they would normally appear, if the search results page is being viewed by the targeted zone of the potential buyers. For example, if a prospective buyer Valerie is in a targeted zone of an item listing 500 (e.g., she is a buyer that has “liked” the NY Giants page on Facebook) and Valerie enters the search query terms “Eli Manning”, “autograph”, and “football”, into a search query bar of the marketplace website, the item listing system 200 may promote the item listing 500 so that it appears higher in a search results page, in comparison to other search result listings for these query terms which are not targeted at any zones to which Valerie belongs. In other words, the item listing system 200 may rank item listings in a search results page being viewed by a particular viewer, based on whether the item listings are being targeted at a zone to which the viewer belongs. That is, item listings targeted at zones to which the viewer belongs may appear higher in the search results page than item listings not targeted at zones to which the viewer belongs.

Consistent with various exemplary embodiments, the item listing system 200 may encourage prospective sellers to sell their product items on a marketplace website (when perhaps they would not have done so otherwise), by providing them with the opportunity to specifically target their item listings to the prospective buyers they would prefer to sell to. For example, many sellers of many product items (e.g., jewellery, collectibles, books, furniture, cars, houses, and so on) have sentimental connections with such items, and desire to sell those items to family, friends, or other users that they believe have a similar appreciation or enthusiasm for the product item. The item listing system 200 provides sellers with the ability to sell their product items to such preferred buyers. As one example, perhaps the seller John selling his Eli Manning autographed football (see FIG. 5) would rather have it go to one of his family members or friends rather than a stranger. As another example, perhaps the user Jane has a 100% silver, antique vase from her grandmother which is very unique and rare, and Jane would rather keep the heirloom in her family, or at least her friends, before selling to the public. The item listing system 200 enables John and Jane to use a “Family” zone or “Friend” zone to list their items. As another example, perhaps Jane would strongly prefer to sell her 100% silver antique vase to fellow enthusiasts or fans of antiques. Jane may utilize the item listing system 200 to post an item listing targeted at groups such as “any users who have purchased housewares in the last 3 months,” or “antique enthusiasts” or “people who have purchased silver products.”

Consistent with various exemplary embodiments, the item listing system 200 may enable a seller to establish—or enhance—a reputation, connection or business relationship that the seller has with members of various specific markets. For example, the item listing 500 generated by the item listing system 200 indicates that the item listing is being marketed exclusively at a particular group of users (e.g., “all users who have “liked” the NY Giants page on Facebook”). For example, see the description section 507 of item listing 500 illustrated in FIG. 5. Accordingly, prospective buyers viewing the listing may appreciate the gesture on the part of the seller of first offering this product item exclusively to them before anyone else, and this may enhance the goodwill shown towards to the seller by the buyers. For example, buyers may show their appreciation for the seller's support of their enthusiast sub-communities by providing the seller with customer loyalty, future business, recommendations, referrals, etc.

According to various exemplary embodiments, the item listing system 200 may provide the seller with recommendations for various zones of potential buyers for exposing an item listing to, based on the type of product item for sale. For example, the item listing system 200 may utilize historical information to determine specific zones of potential buyers most likely to purchase the product item and/or have the greatest interest in the product item. For example, the user interfaces 700 and 800 (see FIGS. 7 and 8) include the zone specification entry fields 702, 802 permitting the user to specify the criteria of a zone. According to another exemplary embodiment, the item listing system 200 may prefill these fields 702, 802 with recommendations for each of the zones. The item listing system 200 may also provide the seller with recommendations as to which zones the item listing should be displayed to at a particular time, and recommendations for how long the item listing should be displayed to different zones, prices for the item listing based on the zones viewing the item listing, and so on. For example, the item listing system 200 may prefill the information in the flow definition area 704 with recommendations regarding certain zones that should be exposed at certain times, under certain conditions, with certain price adjustments, etc. The user can accept one of the more recommendations, or change the recommendations as desired.

The item listing system 200 may generate the aforementioned recommendations in various ways. For example, for a given product item, the item listing system 200 may keep track of historical information indicating zones, conditions, zone exposure flows/timelines, price adjustments, etc., that other sellers have specified for the given product item or similar product items. For example, if the item listing system 200 detects that users listing autographed footballs tend to expose these listings to prospective buyers that “like” the associated team page on Facebook, or users that have previously purchased footballs, etc., then the item listing system 200 may prefill the appropriate information in the user interface 700, 800 when a user wishes to sell an autograph football. The item listing system 200 may also take into account the success that previous sellers have had with item listings for similar product items targeted at various zones. For example, suppose that the item listing system 200 determines that previous item listings for autographed footballs achieve much greater success (e.g., sales) when they are targeted at a zone of users that have previously purchased a football, in comparison to a zone of users that have liked the appropriate team page on Facebook. Accordingly, the item listing system 200 may adjust the recommendations so that Zone 1 corresponds to the users that have liked the appropriate team page on Facebook, while Zone 2 corresponds to users that have previously purchased a football. Thus, the item listing system 200 provides a seller with recommendations for zones of potential buyers of a product item, in order to enable the seller to convert the sale as soon as possible for the best possible price.

According to another exemplary embodiment, the item listing system 200 may display the recommendations to the seller only when necessary (e.g., without displaying the user interfaces of FIG. 7 or FIG. 8). For example, once the item listing is ready, the item listing system 200 may notify a seller (e.g., by e-mail, text message, instant message, via a window in a webpage, etc.) of a recommendation to expose an item listing to a particular Zone 1. If the seller agrees, and if the item is not sold within a predetermined time interval, then the item listing system 200 may transmit another notification to the seller with a recommendation to expose the item listing to Zone 1 and Zone 2, with various price adjustments, etc. According to various exemplary embodiments, a seller may select an “automatic mode” or “self-adjusting seller zone mode” of the item listing system 200, wherein as soon as the item listing is generated, the item listing system 200 immediately exposes the item listing to the appropriate zone, and if the item is not sold within a predetermined time interval, the item listing system 200 may automatically transition the item listing for exposure to more zones or different zones, as described in various embodiments throughout.

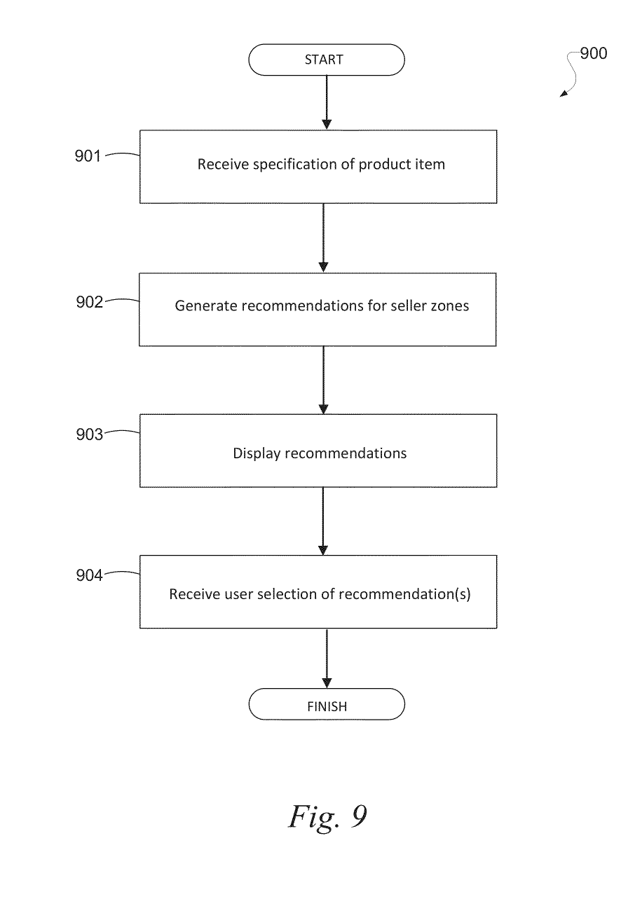

FIG. 9 is a flowchart illustrating an example method 900, according to various embodiments. The method 900 may be performed at least in part by, for example, the item listing system 200 illustrated in FIG. 2 (or an apparatus having similar modules, such as client machines 110 and 112 or application server 112 illustrated in FIG. 1). In 901, the identification module 202 receives a user specification of a product item. For example, the item listing system 200 may display a user interface allowing a seller to identify a product item for listing on a marketplace website. In 902, the identification module 202 generates recommendations for one or more zones or groups of potential buyers of the product item. In 903, the identification module 202 displays the recommendations generated in 902 in a user interface (e.g., see FIG. 7 of FIG. 8) on a device. In 904, the identification module 202 receives the user selection of one or more of the recommendations. For example, the seller may accept the recommendations for zones, and the item listing may be targeted at the zones of potential buyers.

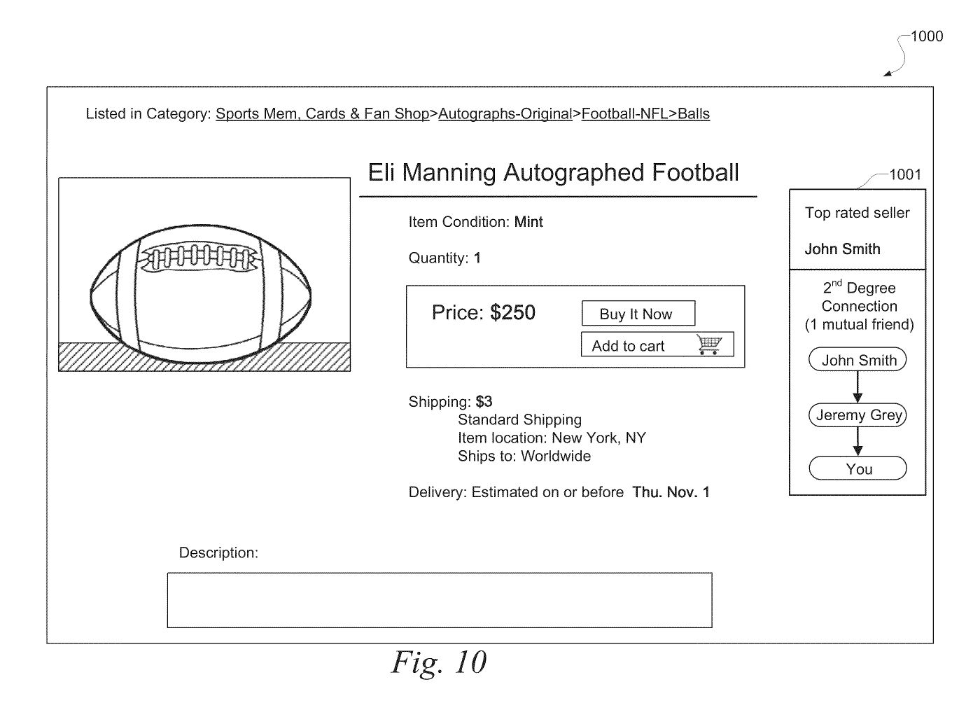

According to various embodiments described above, the item listing system 200 enables a seller to learn more information about prospective buyers, and to target item listings to specific zones or groups of prospective buyers. According to further embodiments described below in conjunction with FIGS. 10-14, the item listing system 200 also enables a prospective buyer to learn more information about various sellers, and to search for product items being offered by specific zones or groups of sellers.

In particular, people can be hesitant to purchase items online from someone they do not know, whereas people are more likely to purchase something if they know the person who they are buying from or if they know someone who can recommend that person. Accordingly, Applicants have determined that the closer the seller is to a personal network of a prospective buyer (e.g., the closer a seller is to the prospective buyer on a social graph), the more likely the prospective buyer is to trust them. On the other hand, the farther out a seller is from the personal network of a prospective buyer (e.g., the farther a seller is from the prospective buyer on a social graph), the less likely the prospective buyer is to trust them. Accordingly, the item listing system 200 enables buyers to find sellers that they trust, and to provide buyers with confidence that they will get the product they ordered and that it will be as described in an item listing.

According to an exemplary embodiment, the item listing system 200 may track how close a seller is on a social graph to a prospective buyer, wherein this information could be displayed when an item is listed online, to thereby augment existing trust metrics, like seller ratings and reviews. For example, when a prospective buyer views an item listing page for the sale of a product item, the item listing system 200 may determine a relationship between the prospective buyer and the seller of the product item. For instance, the identification module 202 may determine the degree of connectedness between the prospective buyer and the seller (e.g., first-degree connection, second-degree degree connection, etc.) on a social graph of a social network service (e.g., Facebook, LinkedIn, etc.). For example,

FIG. 10 illustrates an example of an item listing page 1000 (similar to the item listing page 400 illustrated in FIG. 4). The item listing page 1000 includes seller information 1001 identifying a seller “John Smith”, as well as a degree of connection between the seller and the current viewer (e.g., the seller is a friend of a friend of the viewing user). Thus, the item listing system 200 may permit a prospective buyer of a product item to understand how various sellers of the product item are connected to them on a social graph and/or a social network service. The identification module 202 may access a social network of the prospective buyer by connecting to a social media account of the prospective buyer on a social network service, such as Facebook, Google Plus, Twitter, etc. For example, when setting up or editing an account with a marketplace website, the prospective buyer may provide the item listing system 200 or a marketplace website with user authentication information for accessing various social media accounts of the prospective buyer, such as Facebook, Google Plus, Twitter, etc. The item listing system 200 may then access the social media accounts based on the user authentication information provided by the prospective buyer.

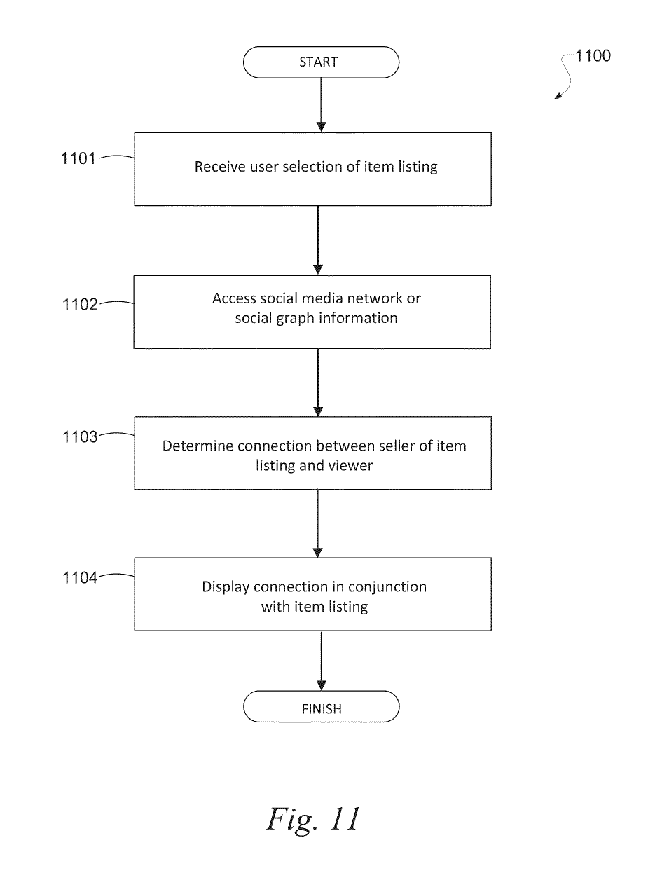

FIG. 11 is a flowchart illustrating an example method 1100, consistent with various embodiments described above. The method 1100 may be performed at least in part by, for example, the item listing system 200 illustrated in FIG. 2 (or an apparatus having similar modules, such as client machines 110 and 112 or application server 112 illustrated in FIG. 1). In 1101, the identification module 202 receives a selection of an item listing by a viewer. For example, the viewer may select a link to an item listing page hosted by a marketplace website. In 1102, the identification module 202 accesses social media network information or social graph information. For example, the identification module 202 may access the social graph from a social media platform or social network service (e.g., Facebook, Twitter, LinkedIn, etc.) via one or more APIs exposed by the respective social media platforms or social network services. In 1103, the identification module 202 determines a connection or relationship between the viewer and the seller of the item listing that was selected by the user in 1101. For example, the identification module 202 may determine that the seller is a first-degree connection (e.g., a friend) of the viewer, or that the seller is a second-degree connection (e.g., a friend of a friend), and so on. In 1104, the identification module 202 generates a display of the item listing selected by the viewer in 1101, wherein the item listing displays the connection between the viewer and the seller associated with the item listing. An example of such an item listing page 1000 is illustrated in FIG. 10, where the item listing page 1000 includes seller information 1001 identifying the degree of connection between the seller and a viewer.

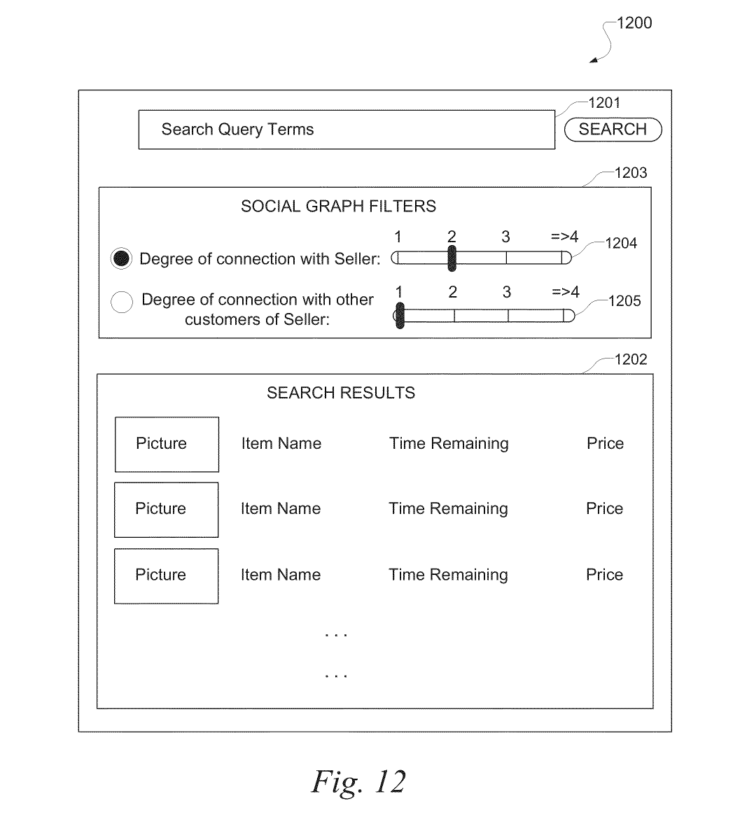

According to another exemplary embodiment, the item listing system 200 permits the prospective buyer to filter information (such as a set of search results or item listings), based on the relationship between the prospective buyer and the various sellers associated with the item listings. For example, FIG. 12 illustrates an exemplary user interface 1200 including a search query bar 1201, where a viewer may enter search query terms for product items and/or item listings. The user interface 1200 also includes a search results section 1202 displaying a list of search results corresponding to the search query terms entered in the search query bar 1201. Moreover, the user interface 1200 includes a social graph filter area 1203 that includes social graph filters 1204, 1205. The social graph filters 1204, 1205 permit the viewer to filter the set of search results in the search results area 1202, based on the relationship between the viewer and the sellers associated with each of the search results in the search results area 1202. For example, the social graph filter 1204 allows the viewer to filter the search results, based on a degree of connection between the seller and the viewer on a social graph (e.g., a social graph associated with the social network service such as Facebook or LinkedIn). In other words, if the viewer drags the selection tab to the notch labelled “1” on the filter bar 1204, the search results area 1202 will only display item listings of sellers that are first-degree connections of the viewer (e.g., sellers that are friends of the viewer on Facebook), whereas if the viewer drags the selection tab to the notch labelled “2” on the filter bar 1204, the search results area 1202 will only display item listings of sellers that are first-degree or second-degree connections of the viewer (e.g., sellers that are friends, or friends of friends, of the viewer on Facebook). The social graph filter 1205 allows the viewer to filter the search results based on a degree of connection between the seller's other customers and the viewer on a social graph. In other words, if the viewer drags the selection tab to the notch labelled “1” on the filter bar 1205, the search results area 1202 will only display item listings of sellers who have previously sold an item to a first-degree connection of the viewer (e.g., sellers that have sold an item to a friend of the viewer on Facebook), whereas if the viewer drags the selection buttons to the notch labelled “2” on the filter bar 1205, the search results area 1202 will only display item listings of sellers who have previously sold an item to a first-degree or second-degree connection of the viewer (e.g., sellers that have previously sold an item to a friend, or a friend of a friend, of the viewer on Facebook). The viewer can use the social graph filters 1204, 1205 separately, or in combination with each other.

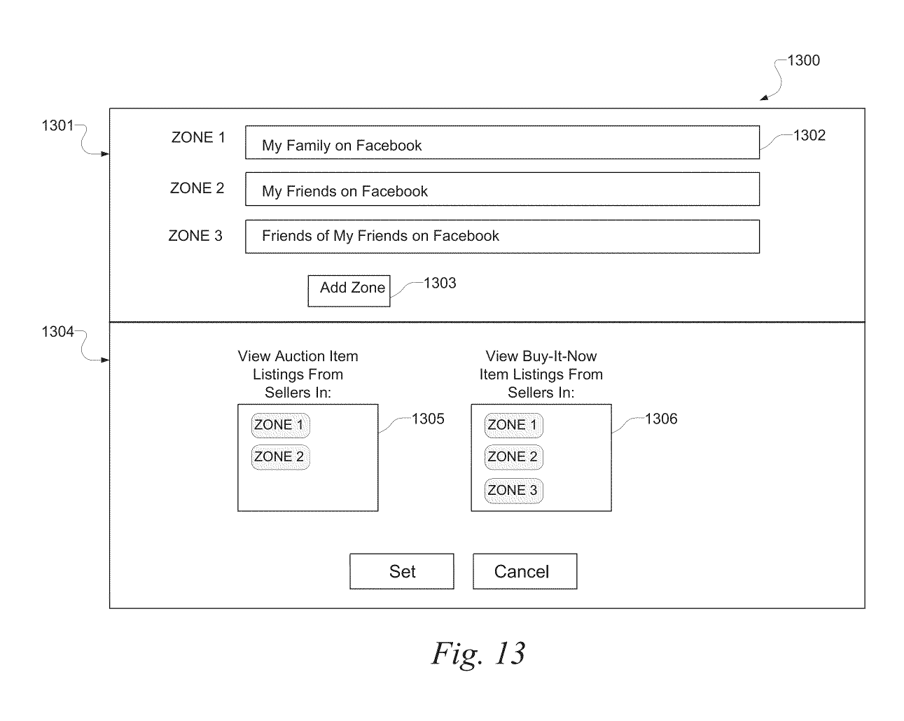

According to another exemplary embodiment, the item listing system 200 enables a prospective buyer to establish social “zones” that they are comfortable buying from. For example, FIG. 13 illustrates an example of a user interface 1300 displayed by the item listing system 200 that allows the user to define one or more zones, and to specify types of item listings from various zones of sellers that the user is comfortable buying from. For example, the user interface 1300 includes the zone definition area 1301 including zone definition entry fields 1302 enabling the user to define one or more zones or groups of sellers (e.g., “My Friends on Facebook”). Other examples of zones described throughout this disclosure. The user can also add zones by selecting the “add zone” button 1303. The user interface 1300 also includes an area 1304 enabling the user to specify, for a given type of item listing (e.g., Auction, Buy-It-Now, etc.), zones of sellers that the user is comfortable buying from. As illustrated in FIG. 13, a person may specify in area 1305 that they only want to view auctions from sellers inside zones 1 and 2, and may specify in area 1306 that they would be willing to view other kinds of item listing (e.g. buy-it-now) from sellers in zones 1-3. Based on these settings, if the user performs a search in future for item listings based on various search query terms, the item listing system 200 may filter the search results based on the preferences entered by the user into the user interface 1300.

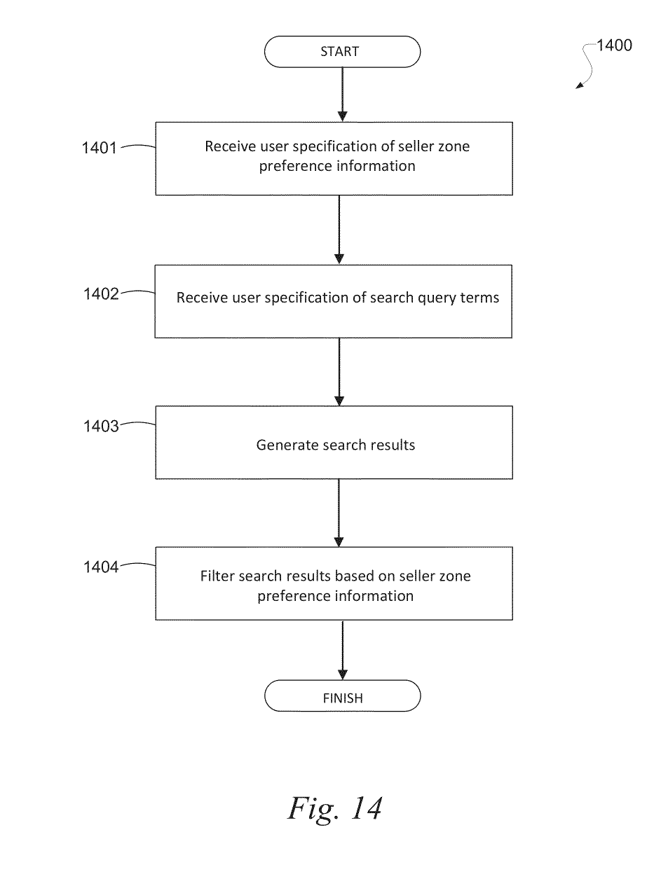

FIG. 14 is a flowchart illustrating an example method 1400, consistent various embodiments described above. The method 1400 may be performed at least in part by, for example, the item listing system 200 illustrated in FIG. 2 (or an apparatus having similar modules, such as client machines 110 and 112 or application server 112 illustrated in FIG. 1). In 1401, the identification module 202 receives a user specification of seller zone preference information indicating zones or groups of sellers that the user is comfortable buying from. For example, the user specification in 1401 may correspond to manipulating filter controls 1204 and 1205 in FIG. 12, or entering information into the user interface 1300 in FIG. 13. In 1402 in FIG. 14, the identification module 202 receives a user specification of one or more search query terms. In 1403, the identification module 202 generates search results based on the search query terms received in 1402. In 1404, the identification module 202 filters the search query results, based on the seller zone preference information received in 1401. For example, if the seller zone preference information indicates that the user only wishes to view information (e.g. search results or item listings) from seller in a particular Zone 1, then the identification module 202 may filter the search results generated in 1403 to only include search results associated with sellers in the particular Zone 1. Various elements of method 1400 may be omitted or rearranged, as necessary. For example, 1401 may occur after 1402 or 1403, and before 1404.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

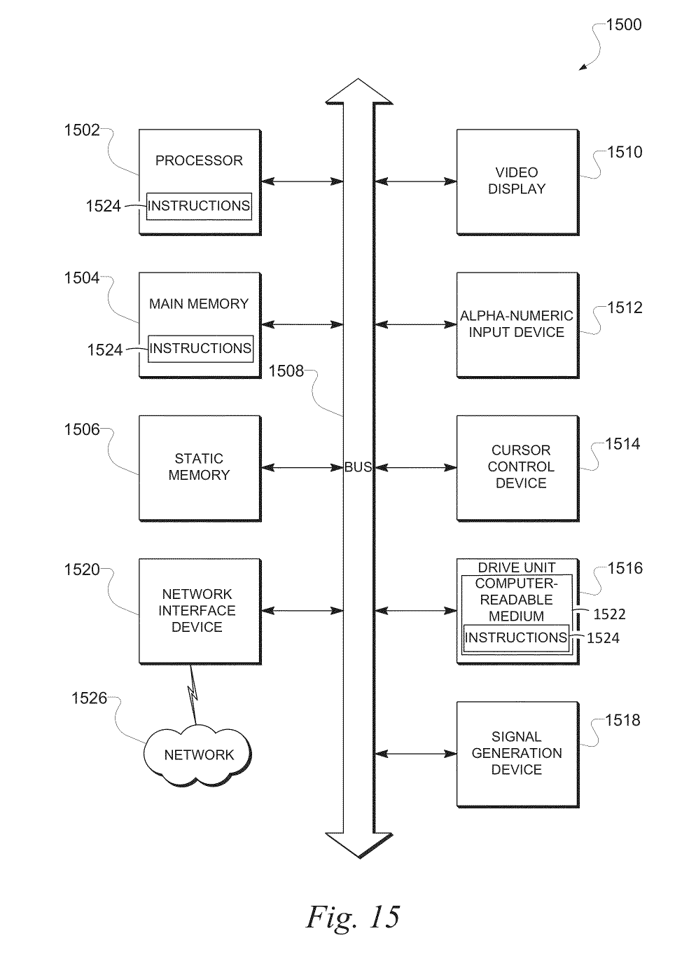

FIG. 15 is a block diagram of machine in the example form of a computer system 1500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard or a touch-sensitive display screen), a user interface (UI) navigation device 1514 (e.g., a mouse), a disk drive unit 1516, a signal generation device 1518 (e.g., a speaker) and a network interface device 1520.

### Machine-Readable Medium

The disk drive unit 1516 includes a machine-readable medium 1522 on which is stored one or more sets of instructions and data structures (e.g., software) 1524 embodying or utilized by any one or more of the methodologies or functions described herein. The instructions 1524 may also reside, completely or at least partially, within the main memory 1504 and/or within the processor 1502 during execution thereof by the computer system 1500, the main memory 1504 and the processor 1502 also constituting machine-readable media.

While the machine-readable medium 1522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An apparatus comprising:
an identification module implemented by one or more processors and configured to identify a first group of potential buyers and a second group of potential buyers of a product item; and
an item listing module configured to:
post, on a marketplace website, an item listing for sale of the product item, the item listing being viewable by the first group of potential buyers;
determine that the product item has not been purchased by at least one member of the first group within a predetermined time interval; and
modify a viewing parameter of the item listing to generate a modified item listing, the modified item listing being viewable by the first and second groups of potential buyers.

2. The apparatus of claim 1, wherein the item listing module is further configured to generate the modified item listing by modifying a sale price, purchase option, or delivery option in the item listing.

3. The apparatus of claim 1, wherein the item listing module is further configured to:
determine that the product item has not been purchased by at least one member of the first group or second group within a second predetermined time interval; and
modify a viewing parameter of the modified item listing to generate an additional modified item listing, the additional modified item listing being viewable by all users of the marketplace website.

4. The apparatus of claim 1, wherein the identification module is further configured to provide a seller of the product item with one or more recommendations of one or more groups of potential buyers of the product item,
wherein the first group or the second group is identified based on a user selection by the seller of a specific one of the recommendations.

5. The apparatus of claim 1, wherein the item listing module is further configured to:
determine that the product item has been purchased by at least one member of the first group within the predetermined time interval; and
close the item listing in response to the determination that the product item has been purchased by at least one member of the first group within the predetermined time interval.

6. A method comprising:
identifying a first group of potential buyers of a product item;
posting, on a marketplace website, an item listing for sale of the product item, the item listing being viewable by the first group of potential buyers;
determining that the product item has not been purchased by at least one member of the first group within a predetermined time interval;
identifying a second group of potential buyers of the product item; and
modifying a viewing parameter of the item listing to generate a modified item listing, the modified item listing being viewable by the first and second groups of potential buyers.

7. The method of claim 6, wherein the first group or the second group is identified based at least in part on user profile information included in social media profiles of users of the marketplace website.

8. The method of claim 6, wherein the first group or the second group is identified based at least in part on user preference information included in social media profiles of users of the marketplace website.

9. The method of claim 6, wherein the first group or the second group is identified based at least in part on purchase histories of users of the marketplace website.

10. The method of claim 6, wherein the first group or the second group is identified based at least in part on a degree of a connection on a social graph between users of the marketplace website and a seller of the product item.

11. The method of claim 6, wherein the first group or the second group is identified based at least in part on a degree of a connection on an online social network service between users of the marketplace website and a seller of the product item.

12. The method of claim 6, wherein the first group or the second group is identified based at least in part on a list of contacts associated with a seller of the product item.

13. The method of claim 6, wherein the first group or the second group is identified based at least in part on geographic locations of users of the marketplace website.

14. The method of claim 6, wherein the first group or the second group is identified based at least in part on a geographic distance between users of the marketplace website and a seller of the product item.

15. The method of claim 6, further comprising generating the modified item listing by modifying a sale price, purchase option, or delivery option in the item listing.

16. The method of claim 6, further comprising:
determining that the product item has not been purchased by at least one member of the first or second groups within a second predetermined time interval; and
modifying a viewing parameter of the modified item listing to generate an additional modified item listing, the additional modified item listing being viewable by all users of the marketplace website.

17. The method of claim 6, further comprising providing a seller of the product item with one or more recommendations of one or more groups of potential buyers of the product item,
wherein the first group or the second group is identified based on a user selection by the seller of a specific one of the recommendations.

18. The method of claim 6, further comprising:
determining that the product item has been purchased by at least one member of the first group within the predetermined time interval; and
closing the item listing in response to the determination that the product item has been purchased by at least one member of the first group within the predetermined time interval.

19. A non-transitory machine-readable storage medium having embodied thereon instructions executable by one or more machines to perform operations comprising:
identifying a first group of potential buyers of a product item;
posting, on a marketplace website, an item listing for sale of the product item, the item listing being viewable by the first group of potential buyers;
determining that the product item has not been purchased by at least one member of the first group within a predetermined time interval;
identifying a second group of potential buyers of the product item; and
modifying a viewing parameter of the item listing to generate a modified item listing, the modified item listing being viewable by the first and second groups of potential buyers.

20. The storage medium of claim 19, wherein the operations further comprise generating the modified item listing by modifying a sale price, purchase option, or delivery option in the item listing.
